(19) United States
(12) Patent Application Publication
(10) Pub. No.: US 2009/0052353 A1
(43) Pub. Date: Feb. 26, 2009

(54) SYSTEM AND METHOD FOR TRANSMISSION TIMESLOT ASSIGNMENT IN WIRELESS TIME DIVISION DUPLEX SYSTEMS

(75) Inventors: Thomas V. D'Amico, Inverness, IL (US); Fan Wang, Chicago, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/844,056

(22) Filed: Aug. 23, 2007

(51) Int. Cl. H04J 3/00

(52) U.S. Cl. 370/280

(57) ABSTRACT

A method and apparatus is provided for assigning transmission slots in a time division duplex system. A time frame overlap determination processor (608) determines (314), based upon consistent observations for a sequence of time periods (220, 222, 224, 226, 228, 230) of a transmitter's time division duplex time frame (210, 212) used by a first transmitter (102), a plurality of timeslots (242) that are likely to experience interference at a first receiver (106) from an adjacent transmitter (108), the adjacent transmitter (108) having a second time division duplex time frame (212) with a definition that is equivalent to the transmitter's time division duplex time frame. A timeslot assignment processor (610) assigns (406, 410, 412), based upon the determining, at least one data packet transmission addressed to the first receiver (106) to a timeslot that is not within the plurality of timeslots of the time frame overlap (202).

### FIELD OF THE INVENTION

The present invention generally relates to the field of data communications, and more particularly relates to time division multiple access scheduling for adjacent transceiver systems.

### BACKGROUND OF THE INVENTION

Time division multiple access (TDMA) is used by some wireless systems, such as WiMAX wireless communications systems, to allow a base station to communicate with multiple remote transceivers (mobiles) by using only one frequency or one frequency band. Time division duplex (TDD) systems separate mobile transmissions from base station transmissions in time rather than in frequency domain as is used, for example, by frequency division duplex systems.

When two (or more) TDD systems operate in adjacent frequency channels and adjacent geographic areas, severe adjacent channel interference may occur. This interference is greatly minimized if both adjacent systems are synchronized with each other in time so that a particular type of transceiver of one system does not transmit when similar types of transceivers of an adjacent system are receiving. In these installations, the base stations and mobiles are synchronized in time so that a mobile does not transmit during a time period that another mobile is receiving a signal from a base station or so that a base station does not transmit during a time period that another base station is receiving. This arrangement of TDD systems greatly minimizes interference from one mobile to another mobile and from one base station to another base station.

In some cases, it may be impractical to synchronize the two systems operating in adjacent channels and adjacent geographic areas. For example, the two systems may have different downlink and uplink time split within one time frame, or may have time offset between their time frames. When the systems are unsynchronized, certain services are especially vulnerable to unacceptable quality of service. Services that are relatively intolerant to high latency or interruption of communication, such as real time voice and video, are susceptible to disruption by adjacent system interference. Therefore, what is needed is an improved method to schedule transmissions to minimize the impact of interference between unsynchronized TDD systems

### SUMMARY OF THE INVENTION

Briefly, in accordance with one aspect of the present invention a method for allocating timeslot utilization in a time division duplex time frame includes determining, based upon consistent observations for a sequence of time periods of a transmitter's time division duplex time frame used by a first transmitter, a plurality of timeslots that are likely to experience interference at a first receiver from an adjacent transmitter. The adjacent transmitter has a second time division duplex time frame with a definition that is equivalent to the transmitter's time division duplex time frame. The method further includes assigning, based upon the determining, at least one data packet transmission addressed to the first receiver to a timeslot that is not within the plurality of timeslots.

In accordance with another aspect of the present invention, a time division duplex time frame transmission scheduler includes a time frame overlap determination processor that determines, based upon consistent observations for a sequence of time periods of a transmitter's time division duplex time frame used by a first transmitter, a plurality of timeslots that are likely to experience interference at a first receiver from an adjacent transmitter. The adjacent transmitter has a second time division duplex time frame with a definition that is equivalent to the transmitter's time division duplex time frame. The time division duplex time frame transmission scheduler further includes a timeslot assignment processor that assigns, based upon the determining, at least one data packet transmission addressed to the first receiver to a timeslot that is not within the plurality of timeslots.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a multiple base station wireless communications system in accordance with one embodiment of the present invention.

FIG. 2 is a block diagram illustration of a time division duplex timeslot overlapping for the multiple base station wireless communications system illustrated in FIG. 1 in accordance with one embodiment of the present invention.

FIG. 3 is a logic flow diagram of a method for determining a timeslot overlap among multiple time division duplex time frames of multiple base station wireless communications system in accordance with one embodiment of the present invention.

FIG. 4 is a logic flow diagram of a method for assigning data packets to transmission timeslots in accordance with one embodiment of the present invention.

FIG. 5 is a logic flow diagram of a timeslot characterization process in accordance with another embodiment of the present invention.

FIG. 6 is a block diagram of an architecture of a base station of FIG. 1 in accordance with one embodiment of the present invention.

FIG. 7 is a block diagram illustrating a time frame comparison for adjacent time division duplex systems with time frame offset in accordance with one embodiment of the present invention.

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as illustrative examples for the claims and as a representative basis for teaching one skilled in the art to variously employ the present invention in virtually any appropriately detailed structure. Further, the terms and phrases used herein are not intended to be limiting; but rather, to provide an understandable description of embodiments of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

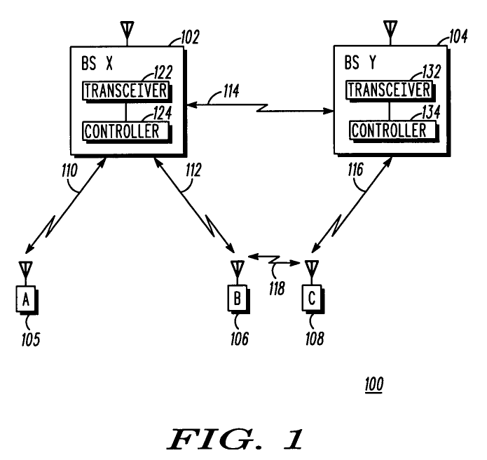

FIG. 1 illustrates a multiple base station wireless communications system 100 in accordance with one embodiment of the present invention. The multiple base station wireless communications system 100 illustrates two base stations, a base station X 102 and a base station Y 104. Base station X 102 is shown to be communicating with two mobiles, that is, a mobile A 105 over a first wireless link 110 and a mobile B 106 over a second wireless link 112. Base station Y 104 is shown to be communicating with mobile C 108 over a third wireless link 116. Each of mobile A 105, mobile B 106, and mobile C 108 comprises a wireless user terminal, such as but not limited to a cellular telephone, a radio telephone, a personal digital assistant (PDA) with radio frequency (RF) capabilities, or a wireless-enabled digital terminal equipment (DTE) such as a laptop computer or a personal computer with a wireless modem, and includes a transceiver having a receiver and transmitter, as is known in the art. Each of base station X 102 and base station Y 104 includes a respective transceiver 122, 132, such as a base transceiver station (BTS) or a Node B, having a receiver and a transmitter, and a respective access network controller 124, 134, such as a base station controller (BSC) or a radio network controller (RNC), as is known in the art. References herein to a transceiver may be a reference to any one or more of base station X 102, base station Y 104, mobile A 105, mobile B 106, and mobile C 108.

The multiple base station wireless communications system 100 uses time division duplex (TDD) protocols for transmissions between the mobiles and base stations. Two adjacent TDD systems, that is, a system using base station X 102 and a system using base station Y 104, transmit and receive data packets using equivalent TDD time frame definitions. The base station X 102 transmits and receives data packets according to a first time division duplex time frame and base station Y 104 transmits and receives data packets according to a second time division duplex time frame, wherein each time frame includes multiple timeslots as is known in the art. Although these two TDD systems use time division duplex time frames that have definition that are equivalent to one another, these two time division duplex time frames are able to be offset in time from one another, as is described in detail below. Equivalent time division duplex time frame definitions, as used herein, includes configurations where both transmitters either (a) utilize approximately the same time frame period, or (b) utilize different time frame periods where the length of multiples of their frame periods are approximately same; for example, two frame periods of a first transmitter are approximately the same length as one frame period of an adjacent transmitter.

The use of TDD protocols among multiple communications systems can result in wireless communication devices receiving interfering transmissions from nearby wireless communications devices operating according to a time division duplex time frame used by an adjacent system. In addition to the intended wireless links described above, unintended wireless links between transceivers are able to exist due to the relative physical locations of the above described transceivers to each other. These unintended wireless links are able to cause unintended interference with one another if transmissions by these transceivers are not properly scheduled.

As an example of unintended interference between transmitters, the proximity of base station X 102 and base station Y 104 allows these two base stations to also receive signals from each other over a fourth wireless link 114. As one example of unintended interference through this link, mobile B 106 transmits a signal to base station X 102. A transmission from base station Y 104, which occurs at the same time as the transmission by mobile B 106, is able to interfere with reception at base station X 102 of the signal from mobile B 106 by being received over the fourth wireless link 114. Since the transmission from mobile B 106 generally has less power than the transmission from base station Y 104, the transmission from mobile B 106 is not properly received at base station X 102. Proper synchronization of the time division duplex time frames between base station X 102 and base station Y 104 would preclude this interference. In the absence of such synchronization, one embodiment of the present invention operates to determine these time division duplex time frame overlaps to improve the probability of transmission success.

As another example of unintended interference between transmitters, the relative proximity of mobile B 106 and mobile C 108 allows a transmission from one of these transceivers to be received by the other over a fifth wireless link 118. In the case of base station X 102 having an unsynchronized time division duplex time frame with base station Y 104, a transmission from mobile C 108 may be carried through the fifth wireless link 118 and interfere with an intended transmission from base station X 102 to mobile B 106 that occurs at the same time. This interference is able to be caused because the much lower propagation loss between the closely located mobile B 106 and mobile C 108 allows the transmission from mobile C 108 to overpower the stronger transmission from base station X 102 due to the greater propagation loss from base station X 102 to mobile B 106.

In the above described example for the multiple base station wireless communications system 100 wherein mobile C 108 interferes with signal reception by mobile B 106, the mobile A 105 is located more physically remotely from mobile C 108. Although the transmission time division duplex time frames used by adjacent base station X 102 and base station Y 104 overlap and cause reception by mobile B 106 to be interfered with by transmissions from mobile C 108, the transmissions of mobile C 108 are unlikely to interfere with reception at mobile A 105 due to the physical separation between these two devices. In this case, although base station X 102 may determine that some downlink timeslots are unreliable for transmissions to mobile B 106 due to interference from mobile C 108, those same timeslots are able to be used for transmissions to mobile A 105 since the propagation loss between mobile C 108 and mobile A 105 is sufficiently large to allow successful reception by mobile A 105 of transmissions from base station X 102.

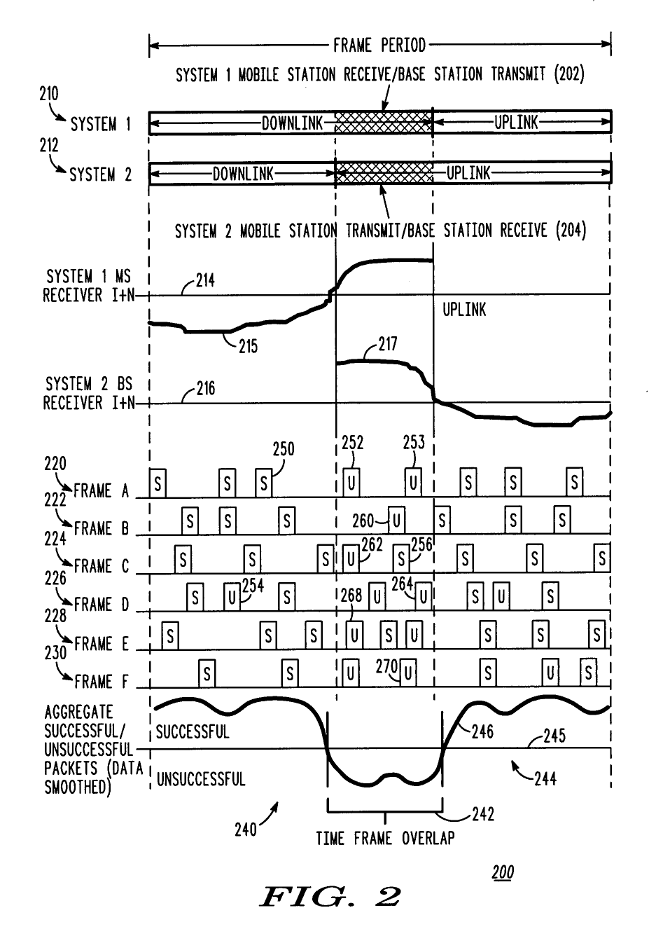

FIG. 2 illustrates time division duplex timeslot overlapping 200 for the multiple base station wireless communications system 100 illustrated in FIG. 1 in accordance with one embodiment of the present invention. The time division duplex timeslot overlapping 200 illustrates time division duplex time frames for two adjacent wireless communications systems, a system one time division duplex time frame 210 and a system two time division duplex time frame 212. System one and system two in this example represent two adjacent wireless communications systems that use equivalently defined time division duplex time frames, such as the systems using base station X 102 and base station Y 104, respectively.

In one embodiment of the present invention, system one and system two each uses a time division duplex time frames that have a definition that is equivalent to the other system and that is divided into two portions. One portion of the time division duplex time frame is referred to as a downlink portion and contains timeslots designated for data transmission from the base station to mobiles. The other portion of the time division duplex time frame is referred to as an uplink portion and contains timeslots that are designated for data transmission by mobiles to the base station. In this embodiment, the time division duplex time frame has a downlink portion at the beginning of the time frame definition and has uplink timeslots at the end of the time frame definition.

Two or more wireless communications systems that are geographically adjacent to each other can have transmissions that interfere with each other. Some installations of two or more adjacent wireless communications systems synchronize the time division duplex time frames of the adjacent systems to ensure that the downlink timeslots and uplink timeslots of both systems all occur at the same time. In such synchronized systems, the downlink transmissions of one system do not, for example, interfere with the uplink communications of the adjacent system. The two adjacent wireless communications systems illustrated in this embodiment, however, are not synchronized and there is an overlap of the downlink of one wireless system with the uplink of the other, adjacent wireless system. In such a case, it is possible to experience the interference described above as carried by the fourth wireless link 114 and the fifth wireless link 118.

The time division duplex timeslot overlapping 200 illustrates that the system one time division duplex time frame 210 has a system one mobile receive and base station transmit period 202, i.e., a downlink period, that overlaps with a system two mobile transmit and base station receive period 204, i.e., an uplink period, of the system two time division duplex time frame 212. The system one mobile receive and base station transmit period 202 and the system two mobile transmit and base station receive period 204 occur during a time frame overlap 242. In this example, the time frame overlap 242 is a period of time, or a portion of a time frame, during which the uplink timeslots of the system two time division duplex time frame 212 overlaps with the downlink timeslots of the geographically adjacent system one time division duplex time frame 210. As is described below, in an embodiment of the present invention, transceivers identify the time frame overlap 242 by identifying a plurality of timeslots that experience, at a receiver for a plurality of time frame periods of a transmitter's time division duplex time frame, interference from an adjacent transmitter that has a different time division duplex time frame. On either side of the time frame overlap 242 are a first non-overlap time frame portion 240 and a second non-overlap time frame portion 244. Transmissions during these two non-overlap time frame portions do not experience the elevated interference from the adjacent time division duplex system that is observed during time frame overlap 242.

In an embodiment of the present invention, the transceivers operate to monitor the received interference and noise (I+N) signal levels during the receiver period for that transceiver according to the time division duplex time frame under which that transceiver is operating. The time division duplex timeslot overlapping 200 illustrates a system one mobile receiver interference and noise (I+N) threshold 214 that is received by a system one mobile and a system two base station receiver interference and noise (I+N) threshold 216 that is received by a system two base station.

The transceivers of this embodiment operate their receivers to measure received interference and noise (I+N) levels during the portion of the time division duplex time frame that is assigned for that type of transceiver to receive data packets. In these embodiments, the base station receivers monitor received interference and noise (I+N) levels during the uplink portion of the time frame and the mobile receivers monitor received interference and noise (I+N) levels during the downlink portion of the time frame.

The time division duplex timeslot overlapping 200 illustrates an example of a system one mobile receiver interference and noise (I+N) measurement 215 and an example of a system two base station receiver interference and noise (I+N) measurement 217. The interference and noise (I+N) of both of these measurements has an elevated level in the time frame overlap 242. This higher level of interference and noise (I+N) signal strength during the time frame overlap 242 relative to the other receive timeslots of the time division duplex time frame, i.e., timeslots occurring during time frame portions 240 and 244, is caused by transmitters of adjacent time division duplex systems that use the same time frame definition but with a different downlink and uplink time split within one time frame reflected by the time frame overlap 242. Interference caused by adjacent time division duplex systems that use the same time frame definition but with a different downlink and uplink time split within one time frame causes elevated interference and noise (I+N) levels during approximately the same portion of the normal receive periods for those transceivers for multiple iterations of the time division duplex time frame period. The interference from adjacent time division duplex systems that operate with the same time frame definition but with a different downlink and uplink time split within one time frame can therefore be identified by observing that elevated received interference and noise (I+N) levels occur in approximately the same location of the time division duplex time frame definition over multiple iterations of the time division duplex time frame period. The elevated signal and noise levels that occur during the time frame overlap 242 causes timeslots within the time frame overlap 242 to be timeslots that are likely to experience interference from an adjacent transmitter that operates with the same or equivalent time frame definition but with a different downlink and uplink time split within one time frame.

One embodiment of the present invention operates to avoid assigning transmission timeslots to a transceiver in portions of the time division duplex time frame that are likely to experience interference from an adjacent time division duplex system. In the illustrated time division duplex timeslot overlapping 200, the portion of a frame period that is likely to experience interference, i.e., the time frame overlap 242, is able to be identified by comparing the interference and thermal noise power in different portions of the time frame. An increased interference and noise (I+N) power in the time frame overlap 242 portion of the time frame period is due to the cross downlink/uplink interference from the two systems. For example, a system one mobile may observe increased interference and noise (I+N) power in some timeslots within the downlink portion of its time division duplex time frame when nearby mobiles of system two are transmitting during their uplink period and their uplink period happens to overlap with the downlink period of system one. IBy way of another example, a system two base station may observe increased interference and noise (I+N) signal strength during some timeslots within the uplink portion of its time frame period due to interference from system one base stations that are transmitting during their downlink periods and their downlink periods happen to overlap with the uplink period of system two.

Because the time division duplex time frames of the two adjacent systems described above with respect to FIG. 2 have an equivalent definition and have approximately the same time period, the higher interference and noise (I+N) signal strength observed during overlap 242, relative to other timeslots within the time division duplex time frame (i.e., timeslots occurring during time frame portions 240 and 244), will be consistently observed during multiple timeslots in a sequence of time frame periods corresponding to each of time division duplex time frames 210 and 212, and thus over multiple iterations of the time frames. This scheme is applied by some embodiments of the present invention to identify an overlapping portion for synchronized systems with different uplink/downlink time splits, and for identifying multiple overlapping portions for unsynchronized systems. In these cases, receivers of these two systems' transceivers determine that multiple timeslots within the time frame overlap 242 exhibit higher interference and noise (I+N) signal strength relative to other timeslots within the time division duplex time frame over multiple iterations of the time division duplex time frame period.

The time division duplex timeslot overlapping 200 further illustrates a sequential series of time periods of a transmitter's time division duplex time frame with an indication of timeslots that experienced successful or unsuccessful transmission. The transmission success or failure status for a time frame A 220, a time frame B 222, a time frame C 224, a time frame D 226, a time frame E 228, and a time frame F 230 are shown. These six time frames represent a sequence consisting of multiple iterations of time periods of one of the time division duplex time frames, such as the system one time division duplex time frame 210 or the system two time division duplex time frame 212, i.e., time frame A 220 corresponds to a first time frame transmitted during a first time frame period, time frame B 222 corresponds to a second time frame transmitted during a second time frame period, time frame C 224 corresponds to a third time frame transmitted during a third time frame period, and so on.

In the example of time frame A 220, there are a number of timeslots that had successful transmissions, as indicted by the letter “S,” and some timeslots that had unsuccessful transmissions, as indicated by the letter “U.” For example, a first successful timeslot 250 occurred during the first non-overlap period 240 and a first unsuccessful timeslot 252 and a second unsuccessful timeslot 253 occurred during the time frame overlap 242. The unsuccessful transmissions that occurred during the time frame overlap 242 are generally caused by interference from adjacent time division duplex wireless communications systems that use a similar time frame definition that has different downlink and uplink time split with the wireless communications system experiencing the interference.

The time frames that occur after time frame A 220, i.e., time frame B 222, time frame C 224, time frame D 226, time frame E 228, and time frame F 230, also exhibit transmission success and failure within the non-overlapping portions 240, 244 and the time frame overlap 242, respectively. Some transmission failures do occur during the non-overlap periods, such as an unsuccessful timeslot 254 that occurred during the first non-overlap portion, or period, 240 of time frame D 226. Transmission failures during the non-overlap periods may be caused by, for example, thermal noise or interference from sources other than transmitters of adjacent time division duplex systems that are located in close physical proximity and that use the same time frame definition but with a different downlink and uplink time split within one time frame reflected by the time frame overlap. In general, transmission failures outside of time frame overlap periods, such as time frame overlap period 242, encountered by adjacent time division duplex systems do not consistently occur in the same portion of the time frame used by the time division duplex wireless system. By contrast, the time frame overlap period 242 of the time frames of the time division duplex systems more consistently experience interference from adjacent time division duplex systems and, therefore, more consistently exhibit transmission failures in timeslots within the time frame overlap 242. Some embodiments of the present invention are able to monitor reception success over multiple time periods of the time division duplex time frame to maintain a record of unsuccessful packet transmission over multiple iterations of the time division duplex time frame period. Consistent observations, over a sequence of time periods of the time division duplex time frame, of unsuccessful packet transmission over multiple iterations of the time division duplex time frame period may then indicate, and may be used to determine, that multiple timeslots that are likely to experience interference at the intended receiver from an adjacent transmitter with a similar time division duplex time frame with an equivalent definition. A system may then maintain, for example, at a base station and/or a mobile, a record of unsuccessful packet transmissions based upon reception success that is observed by, and in some instances reported by, a receiver. In another embodiment of the present invention, a system may maintain a record of timeslots, within the time frame over a sequence of time periods of the time division duplex time frame, that require retransmissions in a hybrid ARQ (HARQ) enabled region.

One embodiment of the present invention maintains an aggregation 246 of transmission success and failure statistics for each timeslot of a system's time frame. This timeslot transmission success aggregation 246 may be based, for example, on a simple sum. One example of a sum used to maintain the timeslot transmission success aggregation 246 includes adding one to a value associated with a particular timeslot of the system's time frame in the event of a successful packet transmission and subtracting one from that value in the event of an unsuccessful packet transmission. However, one of ordinary skill in the art realizes that other methods of accumulation may be used to assess the successful/unsuccessful packet transmission history of timeslots within the time frame over a time span of multiple time frames, as the method used to aggregate transmission successes and failures is not critical to the present invention. For example, when operating in a HARQ enabled region, one may aggregate timeslots within the time frame that require packet retransmission over a time period of several time frames where the packet with an unsuccessful transmission may be retransmitted as a function of NACK feedback or a failure to receive an ACK after a packet transmission. The time division duplex timeslot overlapping 200 shows a successful/failed transmission per timeslot aggregation 246 that demonstrates the values of an example aggregation as a function of temporal position in the time frame.

Based on the successful/failed transmission per timeslot aggregation 246 shown in the time division duplex timeslot overlapping 200, a number of timeslots within portion of the time frame period are able to be associated with an overlap between this time division duplex time frame and the time division duplex time frame associated with an adjacent system. As described below, in one embodiment of the present invention, a system, preferably a base station, assigns at least one data packet transmission to a timeslot that is selected based upon being remote in time, within the time division duplex time frame, from the overlap that is associated with the multiple timeslots. In one such embodiment, the system selects a timeslot that is most remote in time from the time frame overlap period, i.e., has the largest number of timeslots between the overlap identified in the current time frame and between the overlap of adjacent time frames, in the transmitter's time division duplex time frame.

The above described overlap consists of timeslots within a period of the time division duplex time frame that were determined to be likely to experience interference based on the larger number of unsuccessful packets during that particular portion of the time division duplex time frame period, which unsuccessful packets were consistently observed over a sequence of multiple time frame overlap periods. In one embodiment, a determination is made as based upon the timeslot transmission success aggregation 246 value exceeding or not exceeding a timeslot transmission success aggregation threshold 245. The timeslot transmission success aggregation threshold 245 may be an empirically based value determined by observation of the timeslot transmission success aggregation 246 value in known conditions. It is to be noted that the time frame overlap portion 242 identified for the time frame is an estimate, since some uncertainty exists and some degree of error is likely in practical systems. Incorporating more observed frames of successful and unsuccessful packet data in the aggregation tends to reduce that uncertainty. In addition, knowledge of the time division duplex time frame structure may be used in the identification process to improve the accuracy of the determination of timeslots that are likely to experience interference. For example, in one case including two adjacent time division duplex systems have synchronized starting and ending of their time frames as shown in FIG. 2, the time division duplex time frame in one of two adjacent time division duplex systems has a different downlink and uplink time split of the time frame as compared to the downlink and uplink time split of the time division duplex time frame of the other system. This difference results in one overlapping portion of the frame period. Conversely, if the time frame in one of two adjacent time division duplex systems is offset in time from the start of the time division duplex time frame of the other system, this offset may result in two overlapping portions.

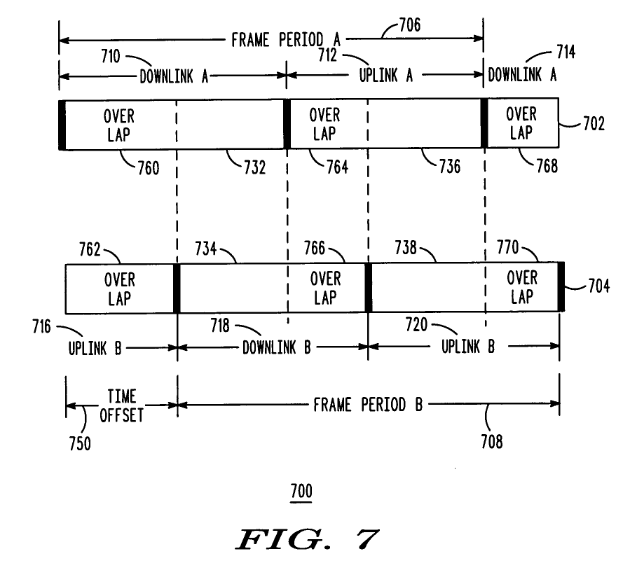

FIG. 7 illustrates a time frame comparison 700 for adjacent time division duplex systems with a time frame offset in accordance with one embodiment of the present invention. The time frame comparison 700 for adjacent time division duplex systems with time frame offset illustrates the time frames of two adjacent time division duplex systems, a time frame A 702 associated with a system A and a time frame B 704 associated with a system B. Time frame A 702 is shown to have a frame period A 706 and time frame B 704 is shown to have a frame period B 708 that is offset from frame period A 706 by a time offset 750.

Each of the two time frames 702, 704 illustrated in the time frame comparison 700 has, in a manner similar to that described above for the time division duplex timeslot overlapping 200, a corresponding downlink portion and uplink portion. For example, the time frame 702, corresponding to time frame period A 706, has a downlink portion, or period, A 710 and an uplink portion, or period, A 712. In a next time frame period after frame period A 706, a next time frame of system A is shown to have a second downlink portion, or period, 714. The time frame 704, corresponding to time frame period B 708, similarly has a downlink portion, or period, B 718 and an uplink portion, or period, B 720. A time frame period that occurs for system B prior to frame period B 708 is shown to have a second uplink portion, or period, 716.

The time offset 750 between the start of the time frame period A 706 and time frame period B 708 results in overlap periods occurring during portions of the downlink. For example, the downlink period A 710 of system A begins with a first overlap period 760 due to overlapping of that downlink period with the uplink period B 716 of system B, which first overlap period 760 of system A corresponds to a second overlap period 762 of system B. Similarly, a third overlap period 764 of system A occurs during the uplink period A 712 and is due to an overlapping of uplink period A 712 of system A with the downlink period B 718 of system B, which third overlap period 764 of system A corresponds to a fourth overlap period 766 of system B. A fifth overlap period 768 of system A then occurs when the second downlink period A 714 of system A overlaps with the uplink period B 720 of system B, which fifth overlap period 768 of system A corresponds to a sixth overlap period 770 of system B.

The time frame comparison for adjacent time division duplex systems with time frame offset 700 illustrates that each frame period has two overlap periods. For example, frame period A 706 has the first overlap period 760 and the third overlap period 764. Frame period B 708 has the fourth overlap period 766 and the sixth overlap period 770. In a manner similar to that described above for the time division duplex timeslot overlapping 200, the portions of these frame periods containing overlaps will be likely to experience elevated interference from an adjacent transmitter.

Therefore aggregation of successful and unsuccessful packets in preceding frames and knowledge of the frame structure is able to assist in the identification of one or more overlapping portions of the frame period.

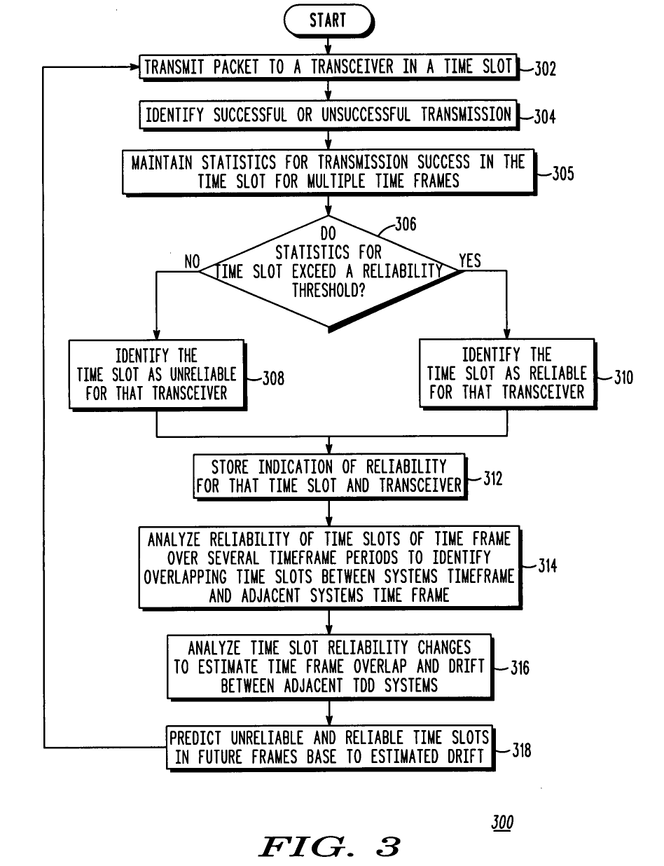

FIG. 3 is a logic flow diagram 300 of a method for determining timeslot overlap for a time division duplex time frames of multiple base station wireless communications system in accordance with one embodiment of the present invention. In one embodiment of the present invention, the method is performed by a time frame overlap determination processor that is located at a wireless communications system base station for a particular wireless communications system, such as at base station X 102 or base station Y 104. The logic flow diagram 300 begins by transmitting, at step 302, a packet that is addressed to a transceiver in a timeslot of a time division duplex time frame. At step 304, the successful or unsuccessful transmission of that packet transmission in the timeslot is identified. Transmission success or failure may be identified, for example, by feedback from the receiver indicating successful or failed transmission, use of an ARQ or HARQ protocol, or any other suitable technique.

At step 305, statistics for transmission success in the timeslot over a sequence of multiple time frames are updated and maintained. One embodiment maintains such statistics by maintaining a counter value that is incremented for each successful transmission and decremented for each failed transmission. Further embodiments are able to incorporate different statistics for successful and failed transmission for each timeslot of the system's time frame over multiple time frame periods.

At step 306, a determination is made as to whether the statistics for the timeslot exceed a reliability threshold, such as the above described timeslot transmission success aggregation threshold 245. If the statistics for a particular timeslot do not exceed a threshold, that timeslot is determined to be likely to experience interference for that receiver for multiple time periods of the time division duplex time frame. That is, if the statistics for the timeslot do not exceed the reliability threshold, then at step 308 the timeslot used for the transmission as unreliable for transmission to that transceiver is identified. If the statistics for the timeslot do exceed the reliability threshold, the logic flow diagram 300 to step 310, where the timeslot is identified as reliable for that transceiver. After identifying the timeslot used for a transmission as either reliable or unreliable, at step 312 an indication of transmission reliability is stored for that timeslot and transceiver.

The logic flow diagram 300 then analyzes, at step 314, the reliability of timeslots within the time frame over a sequence of several time frame periods to identify overlapping timeslots between this system's time frame and the time frame used by an adjacent time division duplex system. In this context, overlapping timeslots are defined as timeslots within this system's time frame that are defined as either uplink timeslots or downlink timeslots and that overlap in time with timeslots within an adjacent time division duplex system that are defined as the other type of timeslot, i.e., a downlink timeslot or an uplink timeslot, respectively. By analyzing the reliability of timeslots over a sequence of several time frame periods, the processing is able to determine, with increased certainty, multiple timeslots that are likely to experience interference at the addressed receiver.

At step 316, changes in the reliability of individual timeslots are analyzed over time. One embodiment of the present invention first determines a set of timeslots that are likely to experience interference at the transceiver for a sequence of time frame periods, as is described for the above steps, and then determines a subsequent set of timeslots that are likely to experience interference during a subsequent set of time frame periods. The processing then may operate to determine whether there is a change in the location, over time, of the multiple timeslots that are likely to experience interference. For example, the processing may operate to determine a time drift between in the interfering overlap between the time division duplex time frame used by this system and the time division duplex time frame used by an adjacent system, Such a time drift may be determined based upon a change in a location of the overlap within the transmitter's time division duplex time frame between a set of timeslots of one time frame and a set of timeslots for a subsequent time frame. Estimating the relative time drift of the overlapping timeslots within a time frame allows better estimations of which timeslots in future time frames are likely to experience interference and is able to be part of determining a plurality of timeslots that are likely to experience interference from an adjacent transmitter with a later time division duplex time frame.

At step 318, unreliable and reliable timeslots are predicted in regard to future time frames for transmission to particular mobiles. The prediction may consider, when observed, the above estimated drift. The logic flow diagram then returns to transmitting, at step 302, a packet to a transceiver in a timeslot.

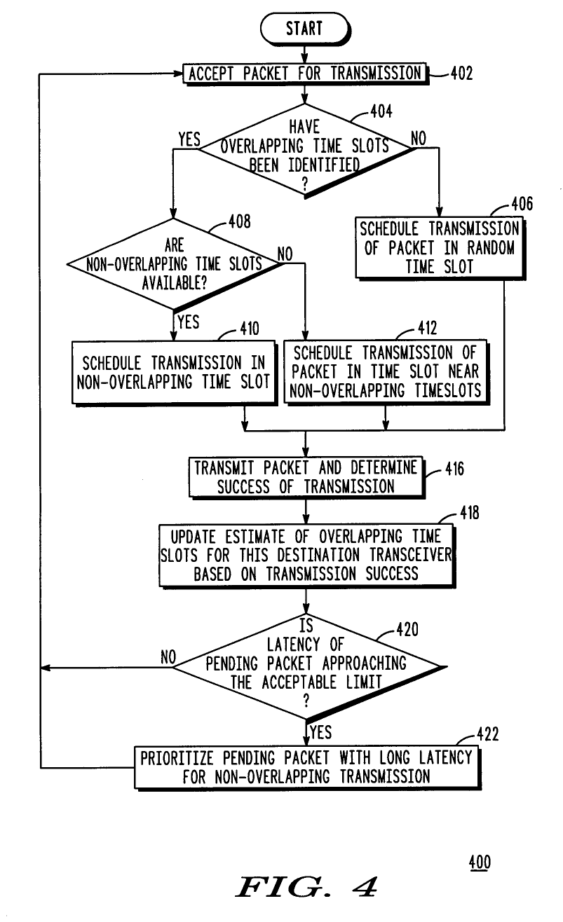

FIG. 4 illustrates a logic flow diagram 400 for assigning data packets to transmission timeslots in accordance with one embodiment of the present invention.

In one embodiment of the present invention, the assigning of data packets to transmission timeslots may be performed by a processor located at a wireless communications system base station for a particular wireless communications system, such as at base station X 102 or base station Y 104. The logic flow diagram 400 begins by accepting, at step 402, a packet for transmission to a destination transceiver. At step 404, it is determined whether non-overlapping timeslots have been identified for transmission to the destination transceiver. The identification of non-overlapping timeslots is described above with respect to logic flow diagram 300. If non-overlapping timeslots have not been identified, the logic flow diagram continues to step 406 and schedules transmission of the data packet in a random timeslot within the time frame used for the time division duplex system.

If non-overlapping timeslots have been identified, the logic flow diagram 400 continues to step 408 and determines if non-overlapping timeslots are available to transmit this data packet. For example, non-overlapping timeslots may not be available if higher priority data packets are queued to be transmitted and already allocated to all of the timeslots that are identified as non-overlapping. If non-overlapping timeslots are available, the logic flow diagram proceeds to step 410 where the transmission of the packet is scheduled in an available non-overlapping timeslot. If non-overlapping timeslots are not available, the logic flow diagram proceeds to step 412 where the transmission of the packet is scheduled in a timeslot of the time division duplex time frame that is near in time to the previously identified non-overlapping timeslots.

After scheduling the data packet for transmission in one of the above described processing steps, the logic flow diagram 400 continues by transmitting the packet and determining, at step 416, the success of the packet transmission. At step 418, the estimate of overlapping timeslots for the destination transceiver is updated based on the above determined transmission success.

At step 420, a determination is made as to whether a latency of any pending packet is approaching a pre-defined acceptable limit set by the time division duplex system for a transmission time. If the latency of any pending packet is approaching the acceptable limit, the logic flow diagram 400 proceeds to step 422 where the pending packet with long latency is prioritized for non-overlapping transmission. After prioritizing the packet with long latency, or if the latency of pending packets is not approaching the acceptable limit, the logic flow diagram 400 returns to step 402, where another data packet is accepted for transmission.

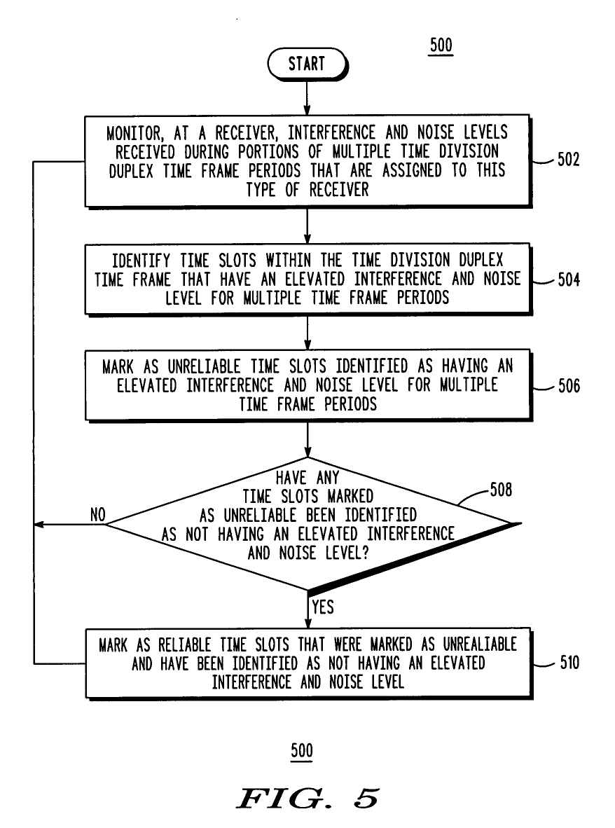

FIG. 5 is a logic flow diagram 500 of a method of timeslot characterization in accordance with another embodiment of the present invention. In one embodiment, the method of logic flow diagram 500 is performed by a time frame overlap determination processor that is similar to the processor performing the method of logic flow diagram 300 described above. The method of FIG. 5 is based upon a monitoring of received interference and noise (I+N) levels, such as the system one mobile receiver interference and noise (I+N) measurement 215 and the system two base station receiver interference and noise (I+N) measurement 217, described above. The logic flow diagram 500 begins by monitoring at a receiver, at step 502, interference and noise (I+N) levels received during portions of multiple time division duplex time frame periods that are assigned to this type of receiver. For example, as described above, a base station's receiver may monitor received interference and noise (I+N) levels during the uplink portion of a time frame and a mobile's receiver may monitor received interference and noise (I+N) levels during a downlink portion of the time frame.

The logic flow diagram 500 then proceeds to step 504, where timeslots within the time division duplex time frame are identified that have an elevated interference and noise (I+N) level for multiple time division duplex time frame periods. In one embodiment, a particular timeslot may be identified as having elevated interference and noise (I+N) level when that particular timeslot within the time frame definition has elevated interference and noise (I+N) in only some of the time frame duplex time frame periods within the multiple time division duplex time frame periods that are monitored in the preceding step.

At step 506, timeslots that have been identified as having an elevated interference and noise (I+N) level for multiple time frame periods are marked as unreliable. These slots are marked as unreliable because they have been determined to be likely to experience interference at that receiver. At step 508, a determination is made as to whether any timeslots that have been marked as unreliable have been identified as not having an elevated interference and noise (I+N) level. Such an observation is able to represent, for example, a change of location within the transmitter's time division duplex time frame of the plurality of timeslots that indicates an overlap time shift in the synchronization between the time division duplex time frames of the two adjacent systems such that a different portion of the time division duplex time frame used by this receiver overlaps with the time division duplex time frame of the adjacent system. If step 508 determines that no timeslots marked as unreliable have been identified as not having an elevated I+N level, the logic flow diagram returns to step 502 and monitors, at a receiver, interference and noise (I+N) levels as is described above. If step 508 determines that one or more timeslots marked as unreliable have been identified as not having an elevated I+N level, the logic flow diagram 500 continues to step 510 and marks, as reliable, timeslots that were marked as unreliable and that have been identified as not having an elevated interference and noise (I+N) level. The logic flow diagram 500 then returns to step 502 and monitors, at a receiver, interference and noise (I+N) levels as is described above.

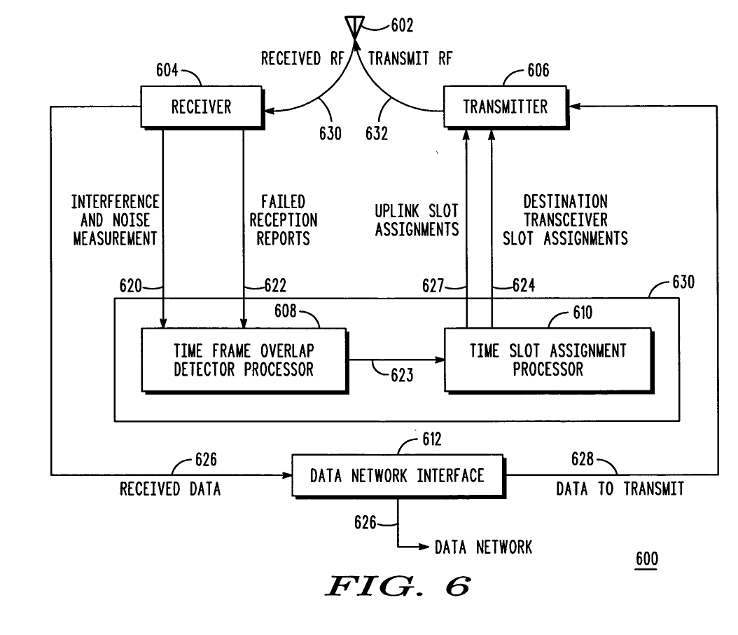

FIG. 6 is a block diagram an architecture of a base station 600, such as base station X 102 or base station Y 104, in accordance with one embodiment of the present invention. FIG. 6 illustrates the equipment located at a base station that is relevant to the processing of one embodiment of the present invention. A typical base station will generally have other communications related equipment located therein, but that is not described here in order to facilitate understanding of one embodiment of the present invention.

The base station 600 includes an antenna 602 that provides received RF 630 to a receiver 604 and accepts transmit RF 632 from a transmitter 606. In one embodiment of the present invention, receiver 604 and transmitter 606 operate to communicate data according to a wireless communications protocol, such as the WiMAX protocol.

Receiver 604 produces received data 626 that is routed to a data network interface 612. The data network interface 612 provides data communications between elements of the base station 600 and a data network 626 that is external to the base station 600. The data network interface 612 also provides data for transmission 628, which is received from the data network 626, to the transmitter 606. Transmitter 606 of one embodiment creates data packets to transmit the data to mobiles according to a time division duplex time frame used by that particular wireless system. As is described below, the transmitter 606 is provided slot assignments 624 that define which timeslots are to be used to transmit to particular mobiles.

Base station 600 further comprises a time division duplex time frame transmission scheduler 630 that includes a time frame overlap detection processor 608 and a time slot assignment processor 610. In various embodiments of the invention, the time frame overlap detection processor 608 and the time slot assignment processor 610 may be separate processors or may be a same processor. The time frame overlap detection processor 608 receives one or both of interference and noise (I+N) measurements 620 and failed reception reports 622 from the receiver 604. The interference and noise (I+N) measurements 620 are produced in one embodiment according to known methods. The failed reception reports 622 are produced in one embodiment by feedback from the receiver 604 and indicate successful or failed transmission, for example, by use of an ARQ or HARQ protocol or any other suitable technique. The time frame overlap detection processor 608 provides overlap definition data 623 to the timeslot assignment processor 610 to support proper scheduling of transmissions so as to avoid an overlap of the time division duplex time frame used by this system with the time division duplex time frame of an adjacent system.

The timeslot assignment processor 610 defines which timeslots within a time division duplex frame are to be used for transmission by either the base station or the mobiles. Destination transceiver timeslot assignments 624 are provided to the transmitter 606 to control which timeslots within the time division duplex time frame are used to transmit downlink data packets to a particular destination transceiver. Timeslots are allocated for each destination transceiver since the interference each transceiver receives may differ due to different geographical relationships with an interfering transmitter. The timeslot assignment processor 610 further provides uplink timeslot assignments 627 to the transmitter to support proper time division duplex time frame definitions and assignment of uplink timeslots to mobiles to reduce the likelihood of their transmissions experiencing interference from a base station in an adjacent time division duplex system that, for example, overlaps the uplink transmission with a downlink transmission in the adjacent time division duplex system.

Typically, the antenna 602 is coupled to a transceiver of the base station 600, such as transceivers 122 and 132 of base stations X 102 and Y 104, the receiver 604 and transmitter 606 are implemented in the transceiver, and the data network interface 612 is implemented in an access network controller of the base station 600, such as access network controllers 124 and 134 of base stations X 102 and Y 104. The time division duplex time frame transmission scheduler 630 may be implemented in either the base station's transceiver or the base station's access network controller, or the functionality of the time division duplex time frame transmission scheduler may be distributed among one or more processors of the transceiver and one or more processors of the access network controller.

The present invention may also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter a/ia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, SIM card, and other permanent storage. Additionally, a computer medium may include, for example, volatile storage such as RAM, buffers, cache memory, and network circuits.

The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Reference throughout the specification to “one embodiment” means that a particular feature, structure, or characteristic described in connection with the embodiment is included in at least one embodiment of the present invention. Thus, the appearances of the phrases “in one embodiment” in various places throughout the specification are not necessarily all referring to the same embodiment. Furthermore, the particular features, structures, or characteristics may be combined in any suitable manner in one or more embodiments. Moreover these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for allocating timeslot utilization in a time division duplex time frame, the method comprising:
determining, for a first time division duplex time frame used by a first transmitter, a plurality of timeslots that are likely to experience interference at a first receiver from an adjacent transmitter, the adjacent transmitter having a second time division duplex time frame with a time frame definition that is equivalent to a time frame definition of the first time division duplex time frame; and
assigning, based upon the determining, at least one data packet transmission addressed to the first receiver to a timeslot that is not within the plurality of timeslots.

2. The method according to claim 1, wherein the determining comprises monitoring reception success for data packets transmitted from the first transmitter to the first receiver for a plurality of time frame periods associated with the first time frame, wherein the plurality of timeslots comprises timeslots within the first time frame that experience a higher failure rate of data packet reception relative to other timeslots within the first time frame over multiple iterations of the time frame period of the first time frame.

3. The method according to claim 1, wherein the determining comprises measuring received interference and noise signal strength for a plurality of time periods of the first time frame, wherein the plurality of timeslots exhibit higher interference and noise signal strength relative to other timeslots within the first time frame over multiple iterations of the time frame period of the first time frame.

4. The method of claim 1, wherein the at least one data packet was previously unsuccessfully transmitted and is selected for the assigning based upon the at least one data packet's approaching a pre-defined transmission time latency time limit.

5. The method according to claim 1, further comprising associating the plurality of timeslots with an overlap between one or more of (1) an uplink portion of the first time division duplex time frame and a downlink portion of the second time division duplex time frame and (2) a downlink portion of the first time frame and an uplink portion of the second time frame, and wherein the assigning further comprises assigning the at least one data packet transmission to a timeslot that is selected based upon being remote in time from the overlap.

6. The method according to claim 5, wherein the timeslot that is selected is most remote in time in the first time division duplex time frame from the overlap.

7. The method according to claim 5, wherein the determined plurality of timeslots comprises a first plurality of time slots and wherein the method further comprises:
determining, subsequent to the determining the first plurality of timeslots, a subsequent, second plurality of timeslots that are likely to experience, at the first receiver during a subsequent plurality of time frame periods, interference from the adjacent transmitter; and
determining an overlap time drift between the first time division duplex time frame and the second time division duplex time frame based upon a change of location within the first time division duplex time frame between the first plurality of timeslots and the second plurality of timeslots.

8. The method according to claim 7, wherein the first time division duplex time frame and the second time division duplex time frame have an equivalent time frame definition and the first time division duplex time frame has an overlap with the second time division duplex time frame, wherein the determining the plurality of timeslots is based at least in part on the overlap, and wherein the assigning further comprises assigning the at least one data packet transmission to a timeslot that is randomly selected from timeslots remote in time from the overlap.

9. The method according to claim 7, further comprising randomly distributing a plurality of data packet transmissions in respective timeslots that are remote in time from the overlap in the first transmitter's time division duplex time frame.

10. A time division duplex time frame transmission scheduler, comprising:
a time frame overlap determination processor adapted to determine, for a first time division duplex time frame used by a first transmitter, a plurality of timeslots that are likely to experience interference at a first receiver from an adjacent transmitter, the adjacent transmitter having a second time division duplex time frame with a time frame definition that is equivalent to a time frame definition of the first time division duplex time frame; and
a timeslot assignment processor adapted to assign, based upon the determining, at least one data packet transmission addressed to the first receiver to a timeslot that is not within the plurality of timeslots.

11. The time division duplex time frame transmission scheduler according to claim 10, wherein the time frame overlap determination processor determines by monitoring reception success for data packets transmitted from the first transmitter to the first receiver for a plurality of time frame periods associated with the first time frame, wherein the plurality of timeslots comprises timeslots within the first time frame that experience a higher failure rate of data packet reception relative to other timeslots within the first time frame over multiple iterations of time frame period of the first time frame.

12. The time division duplex time frame transmission scheduler according to claim 10, wherein the time frame overlap determination processor determines by measuring received interference and noise signal strength for a plurality of time periods of the first time frame, wherein the plurality of timeslots exhibit higher interference and noise signal strength relative to other timeslots within the first time frame over multiple iterations of the time frame period of the first time frame.

13. The time division duplex time frame transmission scheduler according to claim 10, wherein the at least one data packet was previously unsuccessfully transmitted and wherein the timeslot assignment processor further selects the timeslot that is not within the plurality of timeslots that are likely to experience higher interference based upon the at least one data packet's approaching a pre-defined transmission time latency time limit.

14. The time division duplex time frame transmission scheduler according to claim 10, wherein the time frame overlap determination processor further associates the plurality of timeslots with an overlap between one or more of (1) an uplink portion of the first transmitter's time division duplex time frame and a downlink portion of the second time division duplex time frame and (2) a downlink portion of the first time frame and an uplink portion of the second time frame, and wherein the timeslot assignment processor is further adapted to assign the at least one data packet transmission to a timeslot that is selected based upon being remote in time from the overlap.

15. The time division duplex time frame transmission scheduler according to claim 14, wherein the timeslot assignment processor is further adapted to select a timeslot that is most remote in time in the first time division duplex time frame from the overlap.

16. The time division duplex time frame transmission scheduler according to claim 14, wherein the determined plurality of timeslots comprises a first plurality of timeslots and wherein the time frame overlap determination processor is further adapted to:
determine, subsequent to determining the first plurality of timeslots, a subsequent, second plurality of timeslots that are likely to experience, at the first receiver during a subsequent plurality of time frame periods of the first transmitter's time division duplex time frame, interference from the adjacent transmitter; and
determine an overlap time drift between the first time division duplex time frame and the second time division duplex time frame based upon a change of location within the first time division duplex time frame between the first plurality of timeslots and the second plurality of timeslots.

17. The time division duplex time frame transmission scheduler according to claim 16, wherein the first time division duplex time frame and the second time division duplex time frame have an equivalent time frame definition and the first time division duplex time frame has an overlap with the second time division duplex time frame, and wherein the timeslot assignment processor is further adapted to determine the plurality of timeslots of the overlap, and assign the at least one data packet transmission to a timeslot that is randomly selected from timeslots remote in time from the overlap.

18. The time division duplex time frame transmission scheduler according to claim 16, wherein the timeslot assignment processor is further adapted to distributing a plurality of data packet transmissions in respective timeslots that are remote in time from the overlap in the transmitter's time division duplex time frame.

19. An access network controller comprising the time division duplex time frame transmission scheduler of claim 10.

20. A base station comprising the time division duplex time frame transmission scheduler of claim 10.
